(19) United States
(12) Patent Application Publication
(10) Pub. No.: US 2026/0368282 A1
(43) Pub. Date: Nov. 19, 2026

(54) MEMORY AUGMENTED LARGE LANGUAGE MODEL (LLM) CLASSIFICATION FRAMEWORK

(71) Applicant: Optum, Inc., Minnetonka, MN (US)

(72) Inventors: Sanjit Singh BATRA, Millbrae, CA (US); Robert Elliott TILLMAN, Long Island, NY (US); Zhichao YANG, Jersey City, NJ (US); Gregory D. LYNG, Minneapolis, MN (US)

(21) Appl. No.: 19/209,151

(22) Filed: May 15, 2025

(51) Int. Cl. G06F 18/2431; G06N 3/0895

(52) U.S. Cl. CPC G06F 18/2431; G06N 3/0895

(57) ABSTRACT

Various embodiments of the present disclosure provide machine learning architectures and training approaches that improve the functionality of a computer in various aspects. The techniques comprise receiving, using a classification large language model (LLM), an input embedding corresponding to an input data object, generating, using the classification LLM, a contextual embedding, for a classification task, based on the input embedding, generating, using the classification LLM, a memory-augmented embedding by modifying the contextual embedding with a learned memory token specific to the classification task, and providing, using the classification LLM, a classification for the input data object based on the memory-augmented embedding.

### BACKGROUND

In many domains, machine learning technology is implemented within predictive data analysis tools to classify data objects in accordance with various classification tasks. Traditionally, different model architectures may be implemented to better handle nuances, such input lengths, modalities, and/or the like, presented by different aspects of an input data object and/or classification task. For example, large language models (LLMs) may be used for classification tasks that handle text-, image-, or multi-model inputs. However, the accuracy and reliability of LLMs may be dependent on the complexity of the input. For example, LLMs exhibit improved performance with inputs of singular modalities and/or small token sizes. However, the accuracy, precision, and/or recall of such models may decrease as the number modalities and/or tokens within an input grows. This makes LLMs less accurate for long form inputs, such as video sequences, long form documents, and/or the like, due to their inability to capture long-range dependencies within an input data object. These limitations may lead to reduced accuracy and reliability in classification tasks, particularly when dealing with large-scale, unstructured data. For example, traditional language model architectures may exhibit lower performance with respect to input data objects with scattered, subtle, and/or other features that may be overlooked due to the feature's positioning or frequency within an input.

### BRIEF DESCRIPTION OF THE DRAWINGS

FIG. 1 is a block diagram of an example architecture in accordance with some embodiments of the present disclosure.

FIG. 2 is a block diagram of an example predictive data analysis computing entity in accordance with some embodiments of the present disclosure.

FIG. 3 is a block diagram of an example client computing entity in accordance with some embodiments of the present disclosure.

FIG. 4 is a dataflow diagram of a memory augmented LLM framework in accordance with some embodiments of the present disclosure.

FIG. 5 is a dataflow diagram of a training scheme for a memory augmented LLM framework in accordance with some embodiments of the present disclosure.

FIG. 6 is a flowchart diagram of memory augmented LLM process in accordance with some embodiments of the present disclosure.

### DETAILED DESCRIPTION

Various embodiments of the present disclosure provide machine learning architectures and training schemes to improve the functionality of a computer with respect to various machine learning tasks. To do so, some embodiments of the present disclosure provide a memory augmented LLM framework and complementary training scheme that incorporates another knowledge vector tailored to a classification task. The memory augmented LLM framework, for example, may comprise an LLM that is augmented with a learnable memory layer. The learnable memory layer may be composed of a small subset of parameters, learned memory tokens, that record significant tokens with respect to a classification task. During inference, the learnable memory layer may augment a contextual embedding of the LLM with the learned memory tokens to capture long range dependencies within an input data object. By doing so, the learnable memory layer may improve the accuracy, precision, and/or recall of an LLM relative to traditional approaches. The learned memory tokens may be updated through a training scheme in which the layers of the LLM may be trained end to end to improve a loss. In some examples, the loss may be determined using a noise-robust loss function that may reduce the impact of unlabeled data during training. In this way, the memory augmented LLM framework and/or the training scheme of the present disclosure may improve both the predictive performance and training efficiency of LLMs. This, in turn, enables improved performance (e.g., in terms of accuracy, precision, recall) and training speeds with respect to various classification tasks across different domains.

More particularly, some embodiments of the present disclosure provide improved model architectures that address challenges in image-, text-, and multi-modal classification tasks. The improved model architecture integrates a memory mechanism, a learnable memory layer, within a large language model to create a memory augmented LLM framework with improved performance (e.g., in terms of recall, precision, accuracy) relative to traditional LLM frameworks. To overcome performance deficiencies with such traditional frameworks, the memory mechanism of the memory augmented LLM framework may modify contextual embeddings with learned memory tokens specific to a classification task. This allows the model to retain and utilize key information patterns from across the input data object, improving performance particularly for subtle or easily overlooked features within complex (e.g., in terms of length or modalities) inputs. For example, using the techniques of the present disclosure, the memory augmented LLM framework may more effectively process long-form and/or multi-modal inputs by capturing intricate relationships between (a) scattered pieces of information and (b) a classification task through a memory mechanism trained for the classification task. By doing so, the memory augmented LLM framework may capture key long-range dependencies across sections of an input data object, enabling more nuanced and accurate classifications that may handle complex (e.g., in terms of length or modalities) inputs without reductions in predictive accuracy.

In addition, or alternatively, some embodiments of the present disclosure provide an improved training scheme that facilitates the use of the memory mechanism with the memory augmented LLM framework. For example, to address the issue of noisy or incomplete labeling in training data, some embodiments employ a noise-robust loss function that combines cross-entropy loss with a sigmoid modifier. This approach enables a classification LLM to learn more effectively from datasets where true labels may be incomplete or uncertain, a common challenge in real-world machine learning applications. By improving training robustness, the disclosed techniques enable the development of more reliable and generalizable classification models, particularly in domains where clean, fully labeled datasets is challenging or impractical.

Examples of technologically advantageous embodiments of the present disclosure comprise improved machine learning structures, configurable memory mechanisms that may be configurable based on the classification task without a tradeoff in model performance, modifications to traditional training schemes that reduce convergence times and address data deficiencies, among other aspects of the present disclosure. Other technical improvements and advantages may be realized by one of ordinary skill in the art.

### I. OVERVIEW OF EMBODIMENTS

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

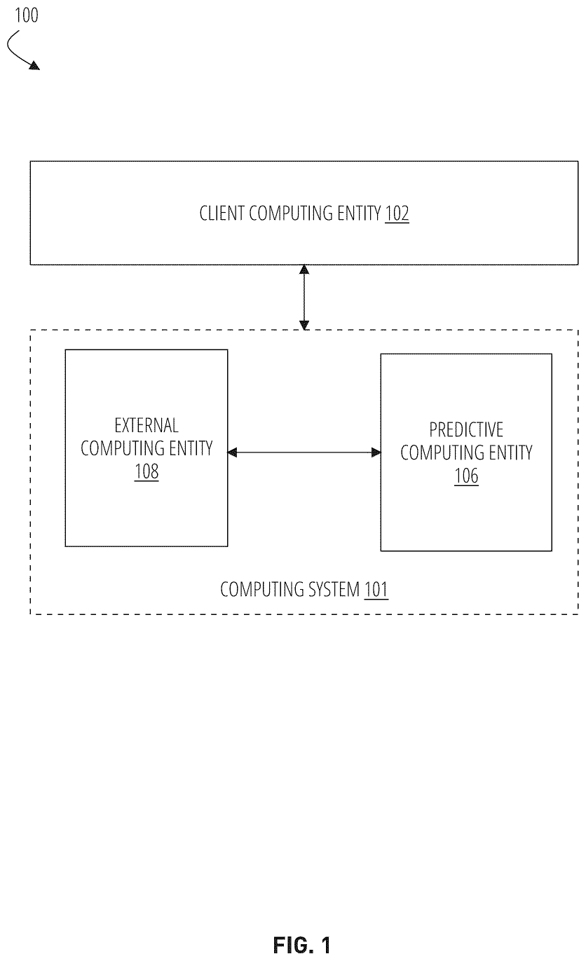

FIG. 1 is a block diagram of an example architecture 100 in accordance with some embodiments of the present disclosure. The architecture 100 comprises a computing system 101 configured to receive a request, such as a classification request, and/or the like, from client computing entities 102, process the request, and provide the responses, such as classifications, to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate embeddings, classification, and/or other machine learned outputs. The models may be adapted to a memory augmented architecture that may improve performance with respect to long form inputs, such as videos, long form documents, and the like.

In some embodiments, the computing system 101 may communicate with at least one of the client computing entities 102 using one or more communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., inference/training techniques) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as input/training datasets, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

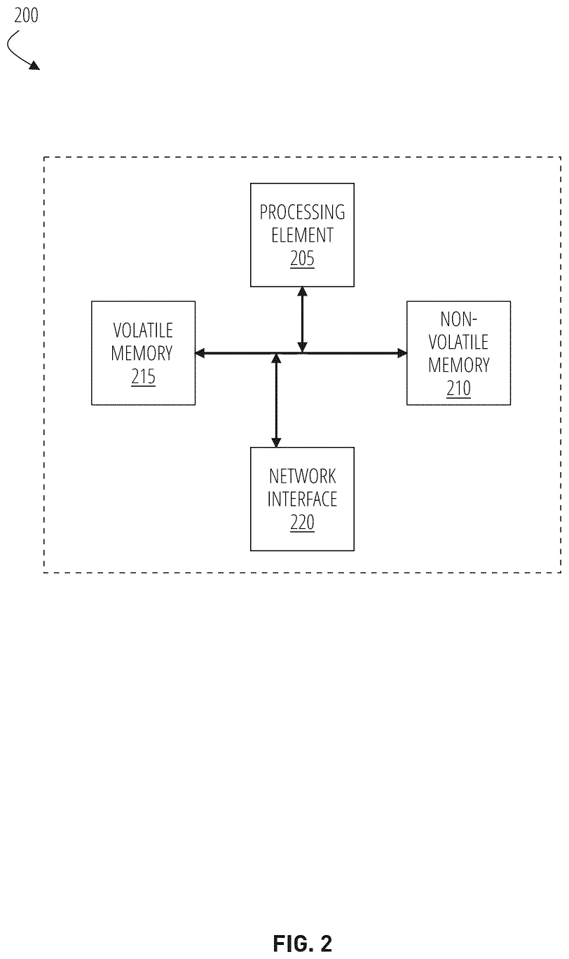

FIG. 2 is a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably), volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilize quantum bits, or qubits, which may exist in multiple states simultaneously through a property called superposition. Unlike classical bits that may only be in a state of 0 or 1, qubits may represent both states at once, allowing for exponentially larger information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

In some embodiments, one or more embodiments of the present disclosure may be implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computer entity 200 may be specialized for machine learning task. By way of example, large language models (LLMs) and other transformer networks may be specially designed for operation within a quantum environment by replacing weight matrices in self-attention and/or multi-layer perceptron layers of such models with one or more combinations of two variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

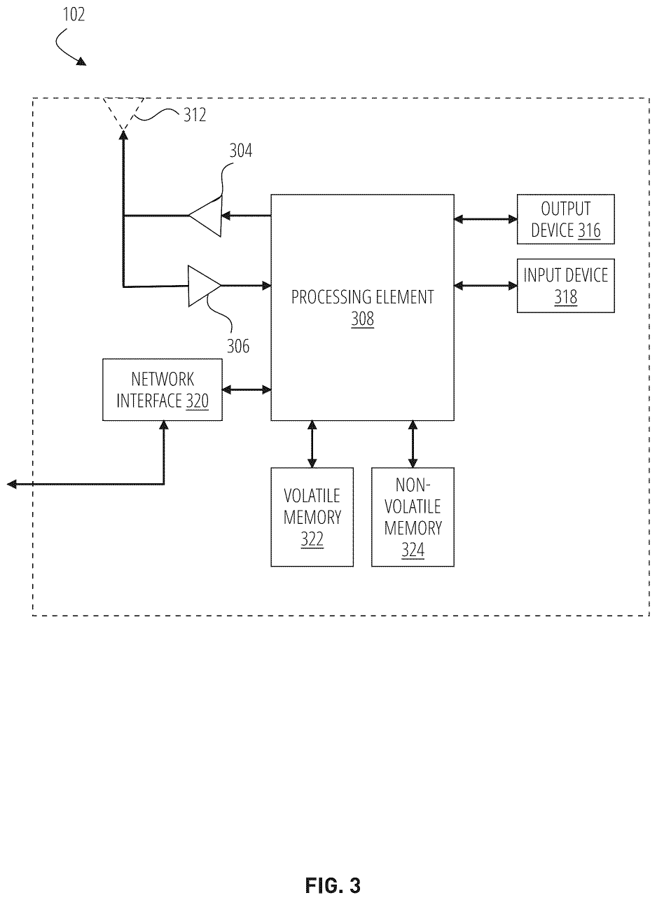

FIG. 3 is a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. EXAMPLE SYSTEM OPERATIONS

As indicated, various embodiments of the present disclosure make important technical contributions to computer functionality. In particular, systems and methods are disclosed herein that implement machine learning and model training techniques to improve model performance with respect to complex inputs. By doing so, the machine learning and model training techniques of the present disclosure enable improved machine learning models that, when executed on a computer, improves predictive accuracy and training efficiencies, among other machine learning improvements. This, in turn, may improve the functionality of a computer with respect to various computing tasks, including model training, data processing, image- or text-based detections, and the like.

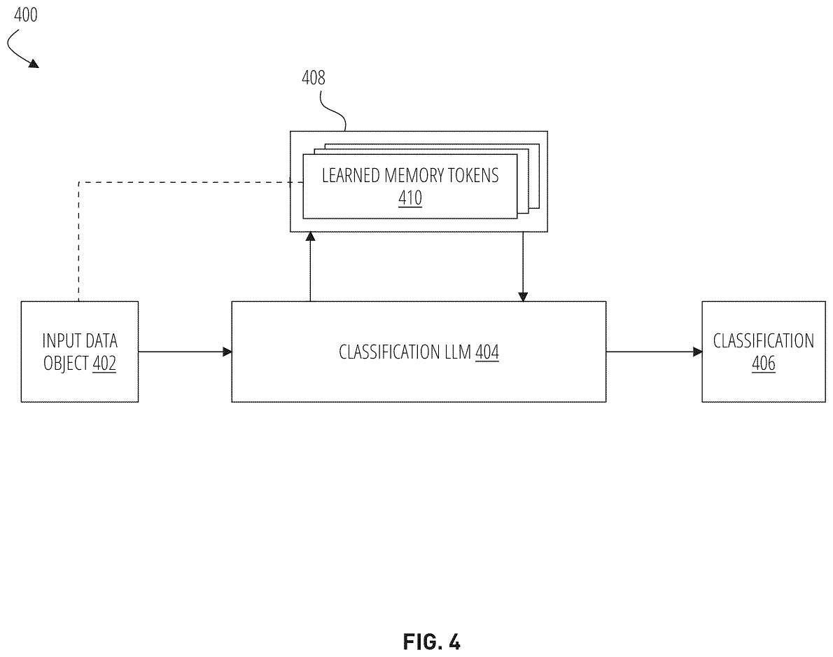

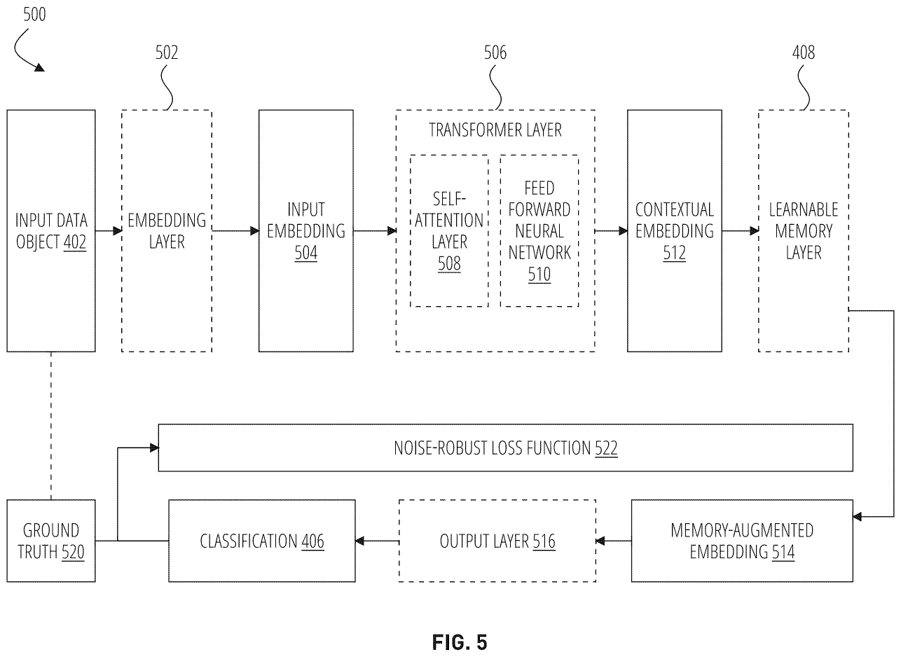

FIG. 4 is a dataflow diagram of a memory augmented LLM framework 400 in accordance with some embodiments of the present disclosure. A computing system, such as the computing system 101, may execute the memory augmented LLM framework 400 to classify images, long-form text, and/or other inputs with increased accuracy by learning and applying tokens of significance despite their positioning within the input. To do so, the computing system 101, and/or another system, may implement an augmented classification LLM 404 that is modified with a learnable memory layer 408. The learnable memory layer 408 may store a set of learned memory tokens 410 for a particular classification task to emphasize a presence of target tokens, with an outsized impact on a classification 406, within a contextual embedding of the classification LLM 404. As described herein with reference to FIG. 5, the classification LLM 404 and the learnable memory layer 408 may be trained, end to end, for the classification task to learn a set of learned memory tokens 410 that improve the performance of the classification LLM 404. Unlike traditional LLMs, the learnable memory layer 408 provides a memory mechanism that provides a separate layer of learned parameters for emphasizing a small subset of target tokens within a domain. This enables the memory augmented LLM framework 400 to update contextual embeddings with learned memory tokens 410 that capture a presence of target token within an input data object 402 without deemphasizing the target token based on its positioning or frequency within the input data object 402. By doing so, the learnable memory layer 408 of the memory augmented LLM framework 400 may capture imperceptible or rare insights traditionally buried within complex inputs and ignored by LLMs. In this way, the memory augmented LLM framework 400 may improve LLM performance (e.g., in terms of accuracy (F1), precision, recall) in general, and more specifically, with respect to long form or complex inputs, such as long form documents, image sequences, and the like, on which traditional LLMs struggle to process.

In some embodiments, the computing system 101 receives an input data object 402. The input data object 402, for example, may comprise one or more images, text files, long form documents, and/or the like.

More particularly, in some embodiments, the input data object 402 comprises an input for classification by a classification LLM 404. The input data object 402 may comprise imagery, text, audio, long form and/or multi-modal files (e.g., long form document, video) with combinations of images, text segments, and/or the like. The input data object 402 may encompass a wide range of data types and/or formats, reflecting the diverse nature of real-world information that machine learning models may be configured for processing. In any form, the input data object 402 may provide a raw input that is fed into the classification LLM 404 for a classification task.

In some examples, an input data object 402 may be preprocessed and/or transformed into a format to improve downstream processing by the classification LLM 404. For example, text-based input data objects 402 may be tokenized, where text segments may be broken down into individual words or subwords (e.g., tokens) and converted into numerical representations using a tokenizer that may be part of or separate from the classification LLM 404. As another example, for image-based input data objects 402, a preprocessing stage may comprise resizing the images into a standard dimension, normalizing pixel values, and/or applying data augmentation techniques to enhance the dimensions within the imagery. In some examples, the images may be processed through one or more convolutional neural networks, vision transformers, and/or the like, that may be part of or separate from the classification LLM 404 to extract relevant features (e.g., tokens). In the case of multi-modal input data objects 402 that comprise a combination of text and imagery, one or more combinations of the above techniques may be applied separately to each portion of the input data object 402 according to the portion's modality. In some example, the preprocessing operations may further comprise a fusion mechanism, that may be part of or separate from the classification LLM 404, that combines the features (e.g., tokens) from each of the encoded portions of the input data object 402 into a unified representation.

The flexibility of input data objects 402 in classification LLMs 404 allows for a wide range of applications and the content, structure, and/or other attributes of the input data object 402 may depend on the particular domain. For example, in a clinical domain, an input data object 402 may comprise a patient's electronic health record, including structured data (e.g., lab results), unstructured data (e.g., physician notes), and/or images (e.g., medical images, computed tomography scans). As another example, in a generalize search or data retrieval domain, an input data object 402 may comprise long-form files, such as long form documents (e.g., books, journals), video sequences (e.g., movies), and/or the like. As yet another example, in a computer security domain, an input data object 402 may comprise security files, such as debugging or activity monitor reports for a large computing ecosystem, and/or the like.

In some embodiments, the computing system 101 provides, using the classification LLM 404, a classification 406 for the input data object 402 based on a memory-augmented embedding, rather than the contextual embedding of a traditional classification LLMs, of the input data object 402. For example, the classification LLM 404 may be augmented with a learnable memory layer 408 (e.g., positioned subsequent to a transformer layer of the classification LLM 404). The learnable memory layer 408 may comprise a set of learned memory tokens 410 that may be learned for a particular classification task. By way of example, the classification task may comprise at least one of a binary classification task and/or a multi-class classification task. The learned memory tokens 410 may be based on at least one defined class of the binary classification task and/or the multi-class classification task. Through a training scheme described with reference to FIG. 5, the learnable memory layer 408 may capture target tokens with an outsized impact on a classification 406 of a classification task. These insights may be infused with a contextual embedding of the classification LLM 404 to improve the performance of the classification LLM 404 with respect to the classification task.

In some embodiments, the classification LLM 404 comprises a large language model that is trained for a classification task. The classification LLM 404, for example, may comprise a specialized type of machine learning model designed to process and analyze complex input data for the purpose of categorizing it into predefined classes and/or categories (e.g., as defined by the classification task). The classification LLM 404 may leverage the advanced natural language processing capabilities of large language models to perform sophisticated classification tasks on various types of input data, including text documents, images, multimodal inputs, and/or the like.

In some examples, the classification LLM 404 may comprise a model architecture that comprises several layers implemented within a computer system. The layers, for example, may comprise one or more embedding layers for initial input processing, transformer layers for contextual understanding, and/or output layers for pooling and transforming insights from the transformer layers into a classification 406. As described in further detail with reference to FIG. 5 the embedding layers may comprise one or more text-based or image-based embedding models to convert input data into numerical representations that may be processed by the subsequent layers of the model. The transformer layers may employ self-attention mechanisms, feed-forward neural networks, and/or the like to generate contextual embeddings that capture the semantic meaning of the input data based on the input embeddings. The output layers may apply pooling mechanisms, such as mean-, max-, min-pooling, softmax function, and/or the like, to activate a classification from the contextual embeddings.

In some embodiments, the classification LLM 404 is trained for a particular classification task by training the model to recognize patterns and/or features in an input data object 402 that are indicative of specific classes. The classification task, for example, may comprise a binary and/or multi-class classification task depending on the domain. In a binary classification use case, the classification task may define a two defined classes and the classification LLM 404 may be trained to distinguish between the two defined classes (e.g., positive vs. negative, presence vs. absence of a condition). In a multi-class classification use case, the classification task may define a set of defined classes and the classification LLM 404 may be trained to distinguish between each of the set of defined classes.

More particularly, in some embodiments, the binary classification task comprises a specific type of classification problem where the objective is to categorize an input data object 402 into one of two mutually exclusive classes or categories. This type of task is fundamental in many areas of machine learning and data analysis, providing a clear yes/no or true/false decision based on the input data object 402. It may be used to detect the presence of a specific disease in a clinical example, a data anomaly in a data processing use case, a security vulnerability in a computer security use case, among other classes specifically defined for any domain.

In the context of a classification LLM 404, a binary classification task may be performed by processing an input data object 402 to make a decision between two possible outcomes. The classification LLM 404 may be trained to recognize patterns and features in the input data object 402 that are indicative of one class or the other, allowing it to make predictions on new, unseen data. By way of example, the input data may be processed through an embedding layer, which converts the raw input (e.g., text, images) into a numerical representation that may be processed by the classification LLM 404. This embedded input then passes through transformer layers, which use self-attention mechanisms to capture contextual information and relationships within the data. The final, output layer of the classification LLM 404 may apply an activation function, such as a sigmoid activation function, to produce a probability score between 0 and 1, representing the likelihood of the input belonging to the positive class. A threshold (e.g., 0.5) may be applied to the probabilistic output to generate the final classification 406. The classification LLM 404 may be trained using a loss function, such as binary cross-entropy, which measures the difference between the predicted probabilities and the true labels, and an optimization function, such as stochastic gradient descent, to update the parameters, weights, and/or other features of the classification LLM 404 to improve its performance with respect to the loss function.

In some embodiments, the multi-class classification task comprises another type of classification problem where the objective is to categorize an input data object 402 into one or more of a set of defined classes and/or categories. This type of task is fundamental in many areas of machine learning and data analysis, by extending the concept of binary classification to scenarios where there are multiple possible outcomes, allowing for more nuanced and detailed detections from input data object 402. It may be used to detect the presence of multiple diseases or disease stages (e.g., mild, early, middle, late stage of cognitive impairment for the Alzheimer's disease) in a clinical example, data anomaly types in a data processing use case, security vulnerability types in a computer security use case, among other classes specifically defined for any domain.

In the context of a classification LLM 404, a multi-class classification task may be performed by processing an input data object 402 to identify one of several possible classes within or associated with an input data object 402. The classification LLM 404 may be trained to recognize patterns and features in the input data object 402 that are indicative of each of a set of defined classes, allowing it to make predictions on new, unseen data. By way of example, the input data may be processed through an embedding layer, which converts the raw input (e.g., text, images) into a numerical representation that may be processed by the classification LLM 404. This embedded input then passes through transformer layers, which use self-attention mechanisms to capture contextual information and relationships within the data. The final, output layer of the classification LLM 404 may apply an activation function, such as a softmax activation function, to produce a probability distribution over all possible classes, representing the likelihood of the input belonging to each of the defined classes. A static threshold (e.g., 0.5) or relative threshold (e.g., class with the highest probability) may be applied to the probability distribution to generate the final classification 406, which may comprise one or more of the defined classes. The classification LLM 404 may be trained using a loss function, such as categorical cross-entropy, which measures the difference between the predicted probability distribution and the true class labels, and an optimization function, such as stochastic gradient descent, to update the parameters, weights, and/or other features of the classification LLM 404 to improve its performance with respect to the loss function.

In any form, the classification task may define at least one defined class, which represents a target of the classification LLM 404. A defined class, for example, may represents a specific category and/or label that an input data object 402 can be assigned to within a classification task. It may be a predetermined and/or distinct grouping that forms part of the output space for a classification LLM 404, serving as a target for the model's predictions.

In accordance with the embodiments of the present disclosure, the performance of the classification LLM 404 with respect to a particular defined class, in any type of classification task, may be improved by adding a learnable memory layer 408 that is configured to learn target tokens that exhibit an increased influence on a classification 406 relative to other tokens within a domain. In this manner, the defined classes of a classification task may shape the learnable memory layer 408, such the learned memory tokens 410 within the learnable memory layer 408 may capture key features and/or patterns that are indicative of each defined class. This allows the classification LLM 404 to refine its contextual embeddings in a way that enhances its ability to distinguish between the different classes of a classification task. By way of example, by separating the learnable memory layer 408 from the transformer layers of the classification LLM 404, the model architecture may allow the classification LLM 404 to capture distinctive features (e.g., target tokens) within an input data object 402 that exhibit an increased predictiveness with respect to a defined class regardless of its positioning, timing, or frequency (e.g., target token) within the input data object 402.

More particularly, in some embodiments, the learnable memory layer 408 comprises a learnable layer of the classification LLM 404 that records a set of learnable learned memory tokens 410 for augmenting a contextual embedding 512 and/or an output vector of the classification LLM 404. By way of example, the learnable memory layer 408 may be positioned after the transformer layers and/or output layers of the classification LLM 404, depending on the embodiment. The learnable memory layer 408 may comprise a memory mechanism which enhances classification performance, such as class imbalance, using an architecture, comprising of a set of parameters in the last stage of the classification LLM 404, that induces the model to learn relevant, but scattered information from the training data. The learnable memory layer 408, for example, may comprise a set of learnable parameters, learned memory tokens 410, that correspond to target tokens within an input data object 402. During training, the learned memory tokens 410 may be designed to enhance the classification LLM's 404 ability to capture and utilize key information patterns across input data objects.

In some examples, a learned memory token of the set of learnable memory tokens may comprise a high-dimensional vector. The vector may be initialized randomly and then learned during the training process to capture important features and patterns relevant to the classification task.

In some embodiments, the number of the set of learned memory tokens 410 within the learnable memory layer 408 may be based on a number of expected tokens within the input data object 402. By way of example, the number of the set of learned memory tokens 410 may comprise a fraction (e.g., 1/10th, 1/1000th) of the number of expected tokens within the input data object 402. In this manner, the set of learned memory tokens 410 may narrow model focus to a relatively small number of target tokens within a complex and varied set of tokens of a particular domain. This allows the classification LLM 404 to efficiently capture key information patterns without excessive computational overhead.

In some embodiments, the number of expected tokens comprises a central tendency, mean, median, mode, or other statistical measure of a set of data objects associated with a domain. By way of example, the number of expected tokens may represent a statistical measure of an observed number of tokens present within data objects for a given classification task. The number of expected tokens may provide a baseline expectation for the length and/or complexity of an input data object 402 that the classification LLM 404 will process to inform a size of the learnable memory layer 408. The number of expected tokens, for example, may informs the design and configuration of various model components, such as the number of parameters of the learnable memory layer 408, to statically or dynamically adjust the size of the learnable memory layer 408 to ensure that the classification LLM 404 allocates a targeted amount of computational resources based on the typical input size. For example, the number of learned memory tokens 410 in the learnable memory layer 408 may be set as a fraction of the expected tokens, balancing between capturing sufficient contextual information and maintaining model efficiency. By way of example, for simple input data objects 402 associated with 100 tokens, the learnable memory layer 408 may comprise a single parameters (e.g., a single learned memory token). For more complex input data objects 402 associated with 100,000 tokens, the learnable memory layer 408 may comprise a set of ten learned memory tokens 410. In this manner, the learnable memory layer 408 may be adapted to any domain or input data object 402 by adjusting the learnable memory layer 408.

In any domain, the learnable memory layer 408 may address several technical challenges in classification tasks by capturing long-range dependencies across the input data object 402. To do so, the learnable memory layer 408 provides a mechanism for the classification LLM 404 to learn and store task-specific patterns that may not be explicitly present in every input example, thereby improving generalization. In addition, or alternatively, the learnable memory layer 408 may reduce class imbalance issues in classification tasks by learning to store patterns specific to underrepresented classes.

By way of example, through the training scheme 500 described with reference to FIG. 5, the learnable memory layer 408 may learn a set of learned memory tokens 410 that correspond to a set of target tokens with an outsized impact on a classification 406. A target token, for example, may comprise a specific element within the input data object 402 that exhibits a strong association with at least one defined class within a classification task. During training, the learnable memory layer 408 may be adjusted to generate learned memory tokens 410 that represent key features or patterns that are strongly indicative of certain classes in the classification task. This improves the capture of long-range dependencies within an input data object 402, the recognition of rare patterns in the case on underrepresented classes, multi-model integration, among other aspects of the classification LLM 404.

FIG. 5 is a dataflow diagram of a training scheme 500 for a memory augmented LLM framework in accordance with some embodiments of the present disclosure. A computing system, such as the computing system 101, may execute the training scheme 500 to improve a performance of an LLM relative to traditional LLM classification architectures. To do so, the computing system 101, and/or another system, may configure an augmented classification LLM by appending a learnable memory layer 408 after a transformer layer 506 (and/or output layer 516) of the LLM. As described herein with reference to FIG. 4, the parameters, such as the number of the learned memory tokens, of the learnable memory layer 408 may be configured for a classification task, and/or the input data objects 402 expected by the classification task. In some examples, multiple iterations of the training scheme 500 may be implemented with varying parameters of the learnable memory layer 408 to further evaluate and refine the performance (e.g., in terms of accuracy (F1), precision, recall) of the classification LLM. At up to each iteration, the layers of the classification LLM, including the embedding layer 502 (if used), the transformer layers 506 (e.g., the self-attention layer 508, feed forward neural network 510), the learnable memory layer 408, and/or the output layer 516 may be trained, end-to-end, to improve a composite model loss function, such as the noise-robust loss function 522 of the present disclosure. In this manner, the learnable memory layer 408 may be modified, during a training iteration, to provide an additional vector of improvement within the LLM's classification architecture. By doing so, the training scheme 500 may improve convergence times, while enhancing the ultimate accuracy, precision, and recall of the classification LLM relative to traditional classification architectures and/or training techniques associated therewith.

In some embodiments, the computing system 101 receives and/or generates, using the classification LLM, an input embedding 504 corresponding to an input data object 402. For example, the classification LLM may comprise an embedding layer 502 that is configured to generate the input embedding 504 based on the input data object 402. The form and/or type of input embedding 504 may be based on the input data object 402. For instance, the input embedding 504 may comprise a multi-modal embedding of a long form document, an image embedding of an image, a text embedding of a text file, and/or the like. In some example,

In some embodiments, the embedding layer 502 comprises at least one of a standalone embedding model (e.g., separate from the classification LLM) and/or an initial layer of the classification LLM that is trained to convert an input data object 402 to an input embedding 504. In the case of the former, the embedding layer 502 may be trained separately from the other layers of the classification LLM. In the case of the later, the embedding layer 502 may be trained with the other layers of the classification LLM. In either case, the embedding layer 502 may comprise a machine learning component that may transform raw, or preprocessed, input data into one or more dense vector representations that capture semantic meaning and relationships between elements (e.g., tokens) of the input data object 402. In some examples, the embedding layer 502 may comprise one or more different neural network architectures based on a modality of the input data object 402, as described herein with respect to the image-based embedding model and text-based embedding model.

In the context of the classification LLM, the embedding layer 502 may be implemented in two primary ways. First, it may be integrated as the initial layer of the classification LLM 404 itself. In this case, the embedding layer 502 may be trained end-to-end with the rest of the model, allowing it to learn representations that are specifically tailored to the classification task at hand. This approach enables the model to fine-tune the embeddings based on the specific patterns and relationships relevant to the classification problem. In addition, or alternatively, the embedding layer 502 may be implemented as a separate model that is not directly incorporated into the classification LLM. In this case, the embedding layer 502 may comprise a pre-trained model that is pre-trained on a large corpus of text to learn general-purpose representations. When used with a classification LLM, these pre-trained embeddings provide a rich starting point for understanding the input data, which may be particularly beneficial when working with limited task-specific training data.

In either embodiment, the embedding layer 502 may comprise at least one of an image-based embedding model and/or a text-based embedding model.

In some embodiments, the image-based embedding model comprises one variation of the embedding layer 502 that comprises an embedding model architecture configured for an image based input. An image-based embedding model, for example, may comprise a specialized neural network architecture designed to transform visual input data into dense vector representations that capture meaningful features and semantic content of images. An image-based embedding model, for example, may comprise one or more convolutional neural networks (CNNs), vision transformers (ViT), and/or the like. In some examples, the image-based embedding models may be designed to extract hierarchical features from images, starting with low-level features like edges and textures in the initial layers, and progressively building up to high-level semantic features in the deeper layers.

In some embodiments, the text-based embedding model comprises another variation of the embedding layer 502 that comprises an embedding model architecture configured for text. A text-based embedding model may comprise a specialized neural network architecture designed to transform textual input data into dense vector representations that capture semantic meaning and relationships between words or phrases. For example, the text-based embedding model may comprise a vocabulary of tokens (e.g., words or subwords) and may be configured to map each token within an input data object 402 to a high-dimensional vector. The vectors may be learned during the training process to capture semantic relationships, such that words with similar meanings or usage patterns have similar vector representations in the embedding space. In some examples, the text-based embedding model may comprise a lookup table-based embedding layer, where each word or subword token in the vocabulary is mapped to a fixed-dimensional vector. These vectors may be initialized randomly and then learned during the training process to capture semantic relationships between words. In addition, or alternatively, the text-based embedding model may leverage contextual information to generate dynamic embeddings that may capture the nuanced meanings of words based on their surrounding context. By way of example, the text-based embedding model may comprise a Bidirectional Encoder Representations from Transformers (BERT), generative pre-trained transformer (GPT), and/or the like.

In some embodiments, the input embedding 504 comprises an initial embedding of the input data object 402 as output from the embedding layer 502. The input embedding 504 The input embedding 504, for example, may comprise one or more numerical vectors representing the semantic meaning of tokens within the input data object 402. These numerical vectors, for example, may comprise a sequence of word embedding, image embeddings, and/or the like, either learned during training and/or obtained from pre-existing embeddings for text and/or image sequences. In this manner, an input embedding 504 may comprise a dense, numerical representation that captures semantic relationships between tokens within an input data object 402.

The computing system 101 may generate, using the classification LLM, a contextual embedding 512, for a classification task, based on the input embedding 504. For example, the classification LLM may comprise a transformer layer 506 configured to generate the contextual embedding 512 based on the input embedding 504.

In some embodiments, the transformer layer 506 comprises one or more learnable layers of the classification LLM subsequent to the embedding layer 502. The transformer layer 506, for example, may comprise a positional encoding layer, one or more self-attention layers 508, one or more feed forward neural networks 510, and/or the like. In some examples, the transformer layer 506 may be designed to process sequential data, such as text, image sequences, and/or the like, by capturing complex relationships and dependencies between different elements of the input sequence. To do so, using a positional encoding layer the transformer layer 506 may add information about the relative and/or absolute position of up to each token within an input sequence. In addition, or alternatively, the transformer layer 506 may comprise one or more self-attention layers 508 that may implement self-attention mechanisms to weigh the importance of different parts of the input sequence when processing each individual token. In some examples, the self-attention layers 508 may be implemented through query, key, and value matrices derived from the input embeddings 504. Attention scores may be determined as the dot product of the query and key matrices, followed by a softmax operation to normalize the scores. The attention score may then be used to create a weighted sum of the value matrices, producing the output of the self-attention operation. In some examples, the self-attention layers 508 may comprise multi-head attention mechanisms, where multiple sets of query, key, and value matrices may be used in parallel. This allows the model to capture different types of relationships within the same input sequence. The outputs from these multiple attention heads may be typically concatenated and passed through a linear transformation.

Following the self-attention layers 508, the transformer layers 506 may comprise one or more feed forward neural networks 510. The feed forward neural network 510 may comprise one or more fully connected networks applied independently to each position in the sequence. In some examples, the self-attention layer 508 may comprise two linear transformations with a non-linear activation function (e.g., ReLU) in between. In some examples, the self-attention layers 508 and/or feed forward neural networks 510 may be wrapped in residual connections and/or layer normalization operations. Residual connections may enable the classification LLM to bypass these components, when necessary, which helps in training very deep networks. Layer normalization may help stabilize the activations for improved training efficiency and model performance.

In some examples, the classification LLM may comprise a set of transformer layers 506 that may be stacked on top of each other. This allows the model to build up increasingly complex and abstract representations of the input data object. The number of transformer layers may vary depending on the specific requirements of the classification task and/or the available computational resources. In some example, the contextual embedding 512 may comprise the final output of a final transformer layer 506 of the classification LLM.

More particularly, in some embodiments, contextual embedding 512 comprises a final embedding representation of the input data object 402 that is output after the last transformer layer 506 of the classification LLM. The contextual embedding 512 may comprise a high dimensional data object representation, which may comprise a sequence of token embeddings H={h₁, h₂, . . . , hₙ} where hᵢ represents the contextual embedding of the i-th token. A contextual embedding 512 may comprise a numerical representation of the input data object 402 that captures the semantic meaning of individual tokens and their context within the larger input sequence. In the framework of a classification LLMs, the contextual embeddings 512 serve as an intermediate representation that encapsulates rich, context-aware information about the input data object 402. Traditionally, the contextual embeddings 512 may be used to generate a classification 406 for a particular classification task. To further improve the performance of the classification LLM, the contextual embedding 512 of the present disclosure may be first modified by a learnable memory layer 408 before serving as the basis of a classification 406.

In some embodiments, the computing system 101 generates, using the classification LLM, a memory-augmented embedding 514 by modifying the contextual embedding 512 with a learned memory token specific to the classification task. For example, the classification LLM may comprise a learnable memory layer 408 configured to generate the memory-augmented embedding 514 based on the contextual embedding 512. The learnable memory layer 408, for example, may be positioned between the transformer layer 506 and an output layer 516 of the classification LLM. In some examples, the computing system 101 may generate the memory-augmented embedding 514 by appending a learned memory token to the contextual embedding 512 based on a presence of a target token within the input data object 402.

In some embodiments, the memory-augmented embedding 514 comprises an enhanced contextual embedding 512 that incorporates additional contextual information through the use of learned memory tokens within the learnable memory layer 408. A memory-augmented embedding 514, for example, may be generated by modifying and/or augmenting a contextual embedding 512 with information stored as is a set of memory tokens M={m₁, m₂, . . . , mₖ}, where each mᵢ represents a learned memory token specific to the classification task. By way of example, the learned memory tokens may be appended to the contextual embedding 512 and a self-attention mechanism may allow the learned memory tokens 410 to store information across different parts of the input data object 402 to capture long-range dependencies across the input data object 402.

By way of example, the self-attention mechanism of the classification LLM 404 may enable the classification LLM to selectively focus on different parts of the input data object 402 when generating the memory-augmented embedding 514. This may be achieved through dot product attention or similar techniques, where the relevance of each learned memory token to different parts of the contextual embedding 512 is computed and used to refine the final representation. In this way, the memory-augmented embedding 514 may enhance the classification LLM's ability to capture long-range dependencies and task-specific patterns within the input data object 402. By appending or combining learned memory tokens with the contextual embedding 512, the classification LLM may retain and/or utilize key information that may otherwise be lost or diluted in standard embedding approaches. This is particularly beneficial for tasks involving complex, multi-modal inputs or where relevant information is scattered across the input data object 402.

In some embodiments, the computing system 101 generates, using the classification LLM, a classification 406 based on the memory-augmented embedding 514. For example, the classification LLM may comprise an output layer 516 that is configured to generate the classification 406.

In some embodiments, the output layer 516 comprises a final processing stage of a classification LLM that produces the classification 406. The output layer 516, for example, may comprise an aggregation mechanism followed by a function that maps the aggregated representation to the desired output format for the classification task. By way of example, the output layer 516 may comprise a neural network layer, such as a mean-pooling operation (and/or max-pooling, attention-based pooling) followed by a fully connected layer with a softmax activation function. The mean-pooling operation may aggregate the information from the memory-augmented embedding 514, reducing the sequence of token representations to a single vector. This vector may then be passed through the fully connected layer, which maps it to a vector of scores corresponding to the defined classes of the classification task. In this manner, the output layer 516 may distill the high-dimensional, contextual information captured by the preceding layers of the classification LLM into a format that directly corresponds to the classification task. For a binary classification task, the output may comprise a single probability value, while for a multi-class task, the output may comprise a probability distribution over all possible classes.

In some embodiments, the computing system 101 trains the classification LLM for a classification task based on a comparison between the classification 406 and a ground truth 520 for the input data object 402. For example, the computing system 101 may train up to each of the embedding layer 502, the transformer layer 506, the learnable memory layer 408, the output layer 516, and/or the like, end to end, for the classification task. For example, the computing system 101 may train the classification LLM using a noise-robust loss function 522. The noise-robust loss function 522, for example, may comprise a cross-entropy loss term and/or a sigmoid modifier.

In some embodiments, the noise-robust loss function 522 comprises a training objective for the classification LLM. The noise-robust loss function 522, for example, may comprise a supervised training techniques that may be designed to reduce the impact of noisy or unreliable labels (e.g., ground truth 520) during the training of a classification LLM. By doing so, the noise-robust loss function 522 may improve the performance of the classification LLM by addressing challenges with training data susceptible to inaccuracies, inconsistencies, and/or incomplete labeling, which is a common challenge in real-world machine learning applications.

In some embodiments, the noise-robust loss function 522 comprises a modified cross-entropy loss that may account for potential label noise with a sigmoid modifier. This modification helps to down-weight the contribution of potentially mislabeled or uncertain data points during the training process. By way of example, the noise-robust loss function 522 may be defined as:

$$L = - {\sum }_{i = 1}^{n} [ {y}_{i} log ( {\hat{y}}_{i} ) + ( 1 - {y}_{i} ) log ( 1 - {\hat{y}}_{i} ) ] \cdot σ ( f ( {x}_{i} ) )$$

where L is the loss, yᵢ is the ground truth 520, ŷᵢ is the predicted probability (or classification 406, f(xᵢ) is the model's output before the final activation, and σ is the sigmoid function. The noise-robust loss function 522 serves to improve the model's ability to learn from imperfect datasets. By reducing the impact of potentially mislabeled examples, it allows the classification LLM to focus on more reliable patterns in the data, leading to improved generalization and robustness.

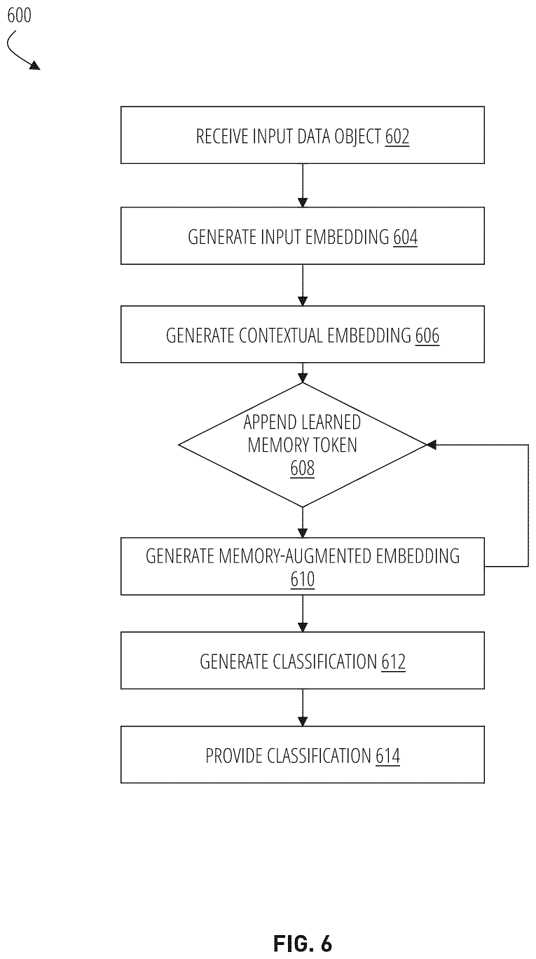

FIG. 6 is a flowchart diagram of memory augmented LLM process 600 in accordance with some embodiments of the present disclosure. The flowchart diagram depicts a machine learning process that improve the predictive accuracy of a machine learning model with respect to various classification tasks. The process 600 may be implemented by one or more computing devices, entities, and/or systems described herein. For example, via the various steps/operations of the process 600, the computing system 101 may process an input data object through a memory-augmented pipeline to enhance contextual embeddings with non-temporal parameters that may capture predictive insights regardless of the insights position within an input. By doing so, the process 600 improves computer functionality by improving the accuracy, precision, and recall of machine learning models, relative to traditional model architectures.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 comprises, at operation 602, receiving an input data object. For example, the computing system 101 may receive the input data object. In some examples, the input data object comprises an image, text, long form document, and/or the like.

In some embodiments, the process 600 comprises, at operation 604, generating input embeddings. For example, the computing system 101 may receive, using a classification LLM, an input embedding corresponding to an input data object. For instance, the classification LLM may comprise an embedding layer that is configured to generate the input embedding based on the input data object. In some examples, the input embedding may comprise a multi-modal embedding of a long form document. In some examples, the embedding layer may comprise at least one of an image-based embedding model and/or a text-based embedding model.

In some embodiments, the process 600 comprises, at operation 606, generating contextual embeddings. For example, the computing system 101 may generate, using the classification LLM, a contextual embedding, for a classification task, based on the input embedding. For instance, the classification LLM may comprise a transformer layer configured to generate the contextual embedding based on the input embedding.

In some embodiments, the process 600 comprises, at operation 608, applying a learned memory token to the contextual embedding. For example, the computing system 101 may apply the learned memory token to the contextual embedding to generate a memory-augmented embedding at operation 610. In some examples, the operation 608 may be repeated for up to each learned memory token of the learnable memory layer. For instance, up to each learned memory token may be applied in response to a determination of the presence of a respective target token within the input data object. By way of example, the computing system 101 may append a learned memory token to the contextual embedding for up to each target token within the input data object.

In some embodiments, the process 600 comprises, at operation 610, generating a memory-augmented embedding. For example, the computing system 101 may generate, using the classification LLM, a memory-augmented embedding by modifying the contextual embedding with a learned memory token specific to the classification task. For instance, the classification LLM may comprise a learnable memory layer configured to generate the memory-augmented embedding based on the contextual embedding. The learnable memory layer, for example, may be positioned between the transformer layer and an output layer of the classification LLM. In some examples, the learnable memory layer may comprise a set of learned memory tokens. The number of the set of learned memory tokens may be based on a number of expected tokens within the input data object. For instance, the number of the set of learned memory tokens may be a fraction of the number of expected tokens. As explained with reference to operation 608, the computing system 101 may generate the memory-augmented embedding by appending a learned memory token to the contextual embedding based on a presence of a target token within the input data object.

In some embodiments, the process 600 comprises, at operation 612, generating a classification. For example, the computing system 101 may generate a classification, using an output layer of the classification LLM, based on the memory-augmented embedding of the input data object.

In some embodiments, the process 600 comprises, at operation 614, providing a classification. For example, the computing system 101 may provide, using the classification LLM, a classification for the input data object based on the memory-augmented embedding.

In some embodiments, the classification LLM is trained for the classification task. For example, up to each of the embedding layer, the transformer layer, and/or the learnable memory layer may be trained, end to end, for the classification task. The classification task, for example, may comprise at least one of a binary classification task and/or a multi-class classification task, and the learned memory tokens of the learnable memory layer may be based on at least one defined class of the binary classification task and/or the multi-class classification task. In some examples, the classification LLM may be trained using a noise-robust loss function that comprises a cross-entropy loss term and a sigmoid modifier.

Some techniques of the present disclosure enable the generation of action outputs that may be performed to initiate one or more real world actions to achieve real-world effects. The techniques of the present disclosure may be used, applied, and/or otherwise leveraged to classify data into predictions. In some examples, the classifications of the present disclosure may trigger action outputs (e.g., through control instructions) to automate computer performance actions, robotic action, medication delivery, and/or the like. The action outputs may control various aspects of a client device, such as the display, transmission, and/or the like of data reflective of an alert, and/or the like. The alert may be automatically communicated to a user and/or may be used to initiate a security protocol (e.g., locking a computer), a robotic action (e.g., performing an automated screening process, an automated injection), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. CONCLUSION

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112 (f) unless traditional means-plus-function language is expressly recited, such as “means for” or “step for” language being explicitly recited in the claim(s).

### V. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.

Example 1. A computer-implemented method comprising receiving, by one or more processors and using a classification large language model (LLM), an input embedding corresponding to an input data object; generating, by the one or more processors and using the classification LLM, a contextual embedding, for a classification task, based on the input embedding; generating, by the one or more processors and using the classification LLM, a memory-augmented embedding by modifying the contextual embedding with a learned memory token specific to the classification task; and providing, by the one or more processors and using the classification LLM, a classification for the input data object based on the memory-augmented embedding.

Example 2. The computer-implemented method of claim 1, wherein the classification LLM comprises (i) an embedding layer configured to generate the input embedding based on the input data object, (ii) a transformer layer configured to generate the contextual embedding based on the input embedding, and (iii) a learnable memory layer configured to generate the memory-augmented embedding based on the contextual embedding.

Example 3. The computer-implemented method of claim 2, wherein the embedding layer, the transformer layer, and the learnable memory layer are trained end to end.

Example 4. The computer-implemented method of claim 2, wherein the learnable memory layer is positioned between the transformer layer and an output layer of the classification LLM.

Example 5. The computer-implemented method of claim 1, wherein (i) the classification LLM comprises an embedding layer, (ii) the input data object comprises a long form document, (iii) the input embedding is a multi-modal embedding of the long form document, and (iv) the embedding layer comprises at least one of an image-based embedding model or a text-based embedding model.

Example 6. The computer-implemented method of claim 1, wherein (i) the classification LLM comprises a learnable memory layer that is positioned subsequent to a transformer layer, (ii) the learnable memory layer comprises a set of learned memory tokens, and (iii) a number of the set of learned memory tokens is based on a number of expected tokens within the input data object.

Example 7. The computer-implemented method of claim 6, wherein the number of the set of learned memory tokens is a fraction of the number of expected tokens.

Example 8. The computer-implemented method of claim 1, wherein generating the memory-augmented embedding comprises appending the learned memory token to the contextual embedding based on a presence of a target token within the input data object.

Example 9. The computer-implemented method of claim 1, wherein the classification LLM is trained using a noise-robust loss function that comprise a cross-entropy loss term and a sigmoid modifier.

Example 10. The computer-implemented method of claim 1, wherein the classification task comprises at least one of a binary classification task or a multi-class classification task, and the learned memory token is based on a defined class of the binary classification task or the multi-class classification task.

Example 11. A system comprising one or more processors; and one or more memories storing processor-executable instructions that, when executed by the one or more processors, cause the one or more processors to perform operations comprising receiving, using a classification large language model (LLM), an input embedding corresponding to an input data object; generating, using the classification LLM, a contextual embedding, for a classification task, based on the input embedding; generating, using the classification LLM, a memory-augmented embedding by modifying the contextual embedding with a learned memory token specific to the classification task; and providing, using the classification LLM, a classification for the input data object based on the memory-augmented embedding.

Example 12. The system of claim 11, wherein the classification LLM comprises (i) an embedding layer configured to generate the input embedding based on the input data object, (ii) a transformer layer configured to generate the contextual embedding based on the input embedding, and (iii) a learnable memory layer configured to generate the memory-augmented embedding based on the contextual embedding.

Example 13. The system of claim 12, wherein the embedding layer, the transformer layer, and the learnable memory layer are trained end to end.

Example 14. The system of claim 12, wherein the learnable memory layer is positioned between the transformer layer and an output layer of the classification LLM.

Example 15. The system of claim 11, wherein (i) the classification LLM comprises an embedding layer, (ii) the input data object comprises a long form document, (iii) the input embedding is a multi-modal embedding of the long form document, and (iv) the embedding layer comprises at least one of an image-based embedding model or a text-based embedding model.

Example 16. The system of claim 11, wherein (i) the classification LLM comprises a learnable memory layer that is positioned subsequent to a transformer layer, (ii) the learnable memory layer comprises a set of learned memory tokens, and (iii) a number of the set of learned memory tokens is based on a number of expected tokens within the input data object.

Example 17. One or more non-transitory computer-readable media storing processor-executable instructions that, when executed by one or more processors, cause the one or more processors to perform operations comprising receiving, using a classification large language model (LLM), an input embedding corresponding to an input data object; generating, using the classification LLM, a contextual embedding, for a classification task, based on the input embedding; generating, using the classification LLM, a memory-augmented embedding by modifying the contextual embedding with a learned memory token specific to the classification task; and providing, using the classification LLM, a classification for the input data object based on the memory-augmented embedding.

Example 18. The one or more non-transitory computer-readable media of claim 17, wherein generating the memory-augmented embedding comprises appending the learned memory token to the contextual embedding based on a presence of a target token within the input data object.

Example 19. The one or more non-transitory computer-readable media of claim 17, wherein the classification LLM is trained using a noise-robust loss function that comprise a cross-entropy loss term and a sigmoid modifier.

Example 20. The one or more non-transitory computer-readable media of claim 17, wherein the classification task comprises at least one of a binary classification task or a multi-class classification task, and the learned memory token is based on a defined class of the binary classification task or the multi-class classification task.

Example 21. The computer-implemented method of example 1, wherein the method further comprises training the classification LLM.

Example 22. The computer-implemented method of example 21, wherein the training is performed by the one or more processors.

Example 23. The computer-implemented method of example 21, wherein the one or more processors are comprised in a first computing entity; and the training is performed by one or more other processors comprised in a second computing entity.

Example 24. The computing system of example 11, wherein the one or more processors are further configured to train the classification LLM.

Example 25. The computing system of example 24, wherein the one or more processors are comprised in a first computing entity; and the classification LLM is trained by one or more other processors comprised in a second computing entity.

Example 26. The one or more non-transitory computer-readable storage media of example 17, wherein the instructions further cause the one or more processors to train the classification LLM.

Example 27. The one or more non-transitory computer-readable storage media of example 26, wherein the one or more processors are comprised in a first computing entity; and the classification LLM is trained by one or more other processors comprised in a second computing entity.

What is claimed is:

1. A computer-implemented method comprising:
receiving, by one or more processors and using a classification large language model (LLM), an input embedding corresponding to an input data object;
generating, by the one or more processors and using the classification LLM, a contextual embedding, for a classification task, based on the input embedding;
generating, by the one or more processors and using the classification LLM, a memory-augmented embedding by modifying the contextual embedding with a learned memory token specific to the classification task; and
providing, by the one or more processors and using the classification LLM, a classification for the input data object based on the memory-augmented embedding.

2. The computer-implemented method of claim 1, wherein the classification LLM comprises:
(i) an embedding layer configured to generate the input embedding based on the input data object,
(ii) a transformer layer configured to generate the contextual embedding based on the input embedding, and
(iii) a learnable memory layer configured to generate the memory-augmented embedding based on the contextual embedding.

3. The computer-implemented method of claim 2, wherein the embedding layer, the transformer layer, and the learnable memory layer are trained end to end.

4. The computer-implemented method of claim 2, wherein the learnable memory layer is positioned between the transformer layer and an output layer of the classification LLM.

5. The computer-implemented method of claim 1, wherein:
(i) the classification LLM comprises an embedding layer,
(ii) the input data object comprises a long form document,
(iii) the input embedding is a multi-modal embedding of the long form document, and
(iv) the embedding layer comprises at least one of an image-based embedding model or a text-based embedding model.

6. The computer-implemented method of claim 1, wherein:
(i) the classification LLM comprises a learnable memory layer that is positioned subsequent to a transformer layer,
(ii) the learnable memory layer comprises a set of learned memory tokens, and
(iii) a number of the set of learned memory tokens is based on a number of expected tokens within the input data object.

7. The computer-implemented method of claim 6, wherein the number of the set of learned memory tokens is a fraction of the number of expected tokens.

8. The computer-implemented method of claim 1, wherein generating the memory-augmented embedding comprises appending the learned memory token to the contextual embedding based on a presence of a target token within the input data object.

9. The computer-implemented method of claim 1, wherein the classification LLM is trained using a noise-robust loss function that comprise a cross-entropy loss term and a sigmoid modifier.

10. The computer-implemented method of claim 1, wherein the classification task comprises at least one of a binary classification task or a multi-class classification task, and the learned memory token is based on a defined class of the binary classification task or the multi-class classification task.

11. A system comprising:
one or more processors; and
one or more memories storing processor-executable instructions that, when executed by the one or more processors, cause the one or more processors to perform operations comprising:
receiving, using a classification large language model (LLM), an input embedding corresponding to an input data object;
generating, using the classification LLM, a contextual embedding, for a classification task, based on the input embedding;
generating, using the classification LLM, a memory-augmented embedding by modifying the contextual embedding with a learned memory token specific to the classification task; and
providing, using the classification LLM, a classification for the input data object based on the memory-augmented embedding.

12. The system of claim 11, wherein the classification LLM comprises:
(i) an embedding layer configured to generate the input embedding based on the input data object,
(ii) a transformer layer configured to generate the contextual embedding based on the input embedding, and
(iii) a learnable memory layer configured to generate the memory-augmented embedding based on the contextual embedding.

13. The system of claim 12, wherein the embedding layer, the transformer layer, and the learnable memory layer are trained end to end.

14. The system of claim 12, wherein the learnable memory layer is positioned between the transformer layer and an output layer of the classification LLM.

15. The system of claim 11, wherein:
(i) the classification LLM comprises an embedding layer,
(ii) the input data object comprises a long form document,
(iii) the input embedding is a multi-modal embedding of the long form document, and
(iv) the embedding layer comprises at least one of an image-based embedding model or a text-based embedding model.

16. The system of claim 11, wherein:
(i) the classification LLM comprises a learnable memory layer that is positioned subsequent to a transformer layer,
(ii) the learnable memory layer comprises a set of learned memory tokens, and
(iii) a number of the set of learned memory tokens is based on a number of expected tokens within the input data object.

17. One or more non-transitory computer-readable media storing processor-executable instructions that, when executed by one or more processors, cause the one or more processors to perform operations comprising:
receiving, using a classification large language model (LLM), an input embedding corresponding to an input data object;
generating, using the classification LLM, a contextual embedding, for a classification task, based on the input embedding;
generating, using the classification LLM, a memory-augmented embedding by modifying the contextual embedding with a learned memory token specific to the classification task; and
providing, using the classification LLM, a classification for the input data object based on the memory-augmented embedding.

18. The one or more non-transitory computer-readable media of claim 17, wherein generating the memory-augmented embedding comprises appending the learned memory token to the contextual embedding based on a presence of a target token within the input data object.

19. The one or more non-transitory computer-readable media of claim 17, wherein the classification LLM is trained using a noise-robust loss function that comprise a cross-entropy loss term and a sigmoid modifier.

20. The one or more non-transitory computer-readable media of claim 17, wherein the classification task comprises at least one of a binary classification task or a multi-class classification task, and the learned memory token is based on a defined class of the binary classification task or the multi-class classification task.
